(19) United States
(12) Patent Application Publication
(10) Pub. No.: US 2004/0225884 A1
(43) Pub. Date: Nov. 11, 2004

(54) Electronic signature system and method

(76) Inventors: Court V. Lorenzini, Mercer Island, WA (US); Thomas H. Gonser, Bellevue, WA (US); Eric C. Ranft, Enumclaw, WA (US); Mir Hajmiragha, Sammamish, WA (US); Jeffrey M. Cochran, Seattle, WA (US)

Correspondence Address: BLACK LOWE & GRAHAM, PLLC, 701 FIFTH AVENUE, SUITE 4800, SEATTLE, WA, 98104, US

(21) Appl. No.: 10/749,814

(22) Filed: Dec. 30, 2003

Related U.S. Application Data
(63) Continuation-in-part of application No. 09/705,964, filed on Nov. 3, 2000.
(60) Provisional application No. 60/213,204, filed on Jun. 21, 2000.

(51) Int. Cl. H04L 9/00

(52) U.S. Cl. 713/176

(57) ABSTRACT

A system for allowing predesignated users at remotely located computer-based systems to perform document signing tasks. The system includes a plurality of remotely located computer-based systems coupled to a document processing computer-based system over a data network. The remotely located computer-based systems allow users at remote locations to sign and designate for signature specific areas within a document that is securely stored at the document processing computer-based system.

### PRIORITY CLAIM

This application is a Continuation-In-Part of U.S. patent application Ser. No. 09/705,964, which claims the benefit of U.S. Provisional Application Serial No. 60/213,204, both of which are hereby incorporated by reference.

### FIELD OF THE INVENTION

This invention relates to digital signatures, and more particularly to electronic signatures placed in specific locations within documents.

### BACKGROUND OF THE INVENTION

A digital signature is an electronic rather than a written signature that can be used by someone to authenticate the identity of the sender of a message or of the signer of a document. It can also be used to ensure that the original content of the message or document that has been conveyed is unchanged. Additional benefits to the use of a digital signature are that it is easily transportable, cannot be easily repudiated, cannot be imitated by someone else, and can be automatically time-stamped.

A digital signature can be used with any kind of message, whether it is encrypted or not, simply so that the receiver can be sure of the sender's identity and that the message arrived intact. A digital certificate contains the digital signature of the certificate-issuing authority so that anyone can verify that the certificate is real.

Assume you were going to send the draft of a contract to your lawyer in another town. You want to give your lawyer the assurance that it was unchanged from what you sent and that it is really from you. First, you might copy-and-paste the contract into an e-mail note. Using hashing software, you would obtain a message hashing (mathematical summary) of the contract. A private key that you have previously obtained from a public-private key (certificate-issuing) authority encrypts the hash. The encrypted hash becomes the digital signature of the message. When the lawyer receives the document with the message, the lawyer's system makes a hash of the received document. The lawyer then uses your public key to decrypt the digital signature of the message (i.e. the encrypted hash) to obtain a hash. If the created hash and the decrypted hash match, the received message is valid.

This method is an effective tool for securely transmitting and signing electronic documents. However, many times with contracts there exists a requirement to have viewers of the document sign or initial various important parts of the document. Therefore, there exists a need for the ability to electronically sign or initial certain specific areas of an electronic document in order to make the electronic signing process more like what is performed in paper versions.

### SUMMARY OF THE INVENTION

The present invention is a digital signature system and method that provides electronic document signing and signing of selected areas within the document. The system includes a plurality of remotely located computer-based systems coupled to a document processing computer-based system over a public data network. The remotely located computer-based systems include a user interface component for displaying an electronic document that the user of the computer-based system desires to sign electronically or to assign signing functions thereto. The user interface component is also responsible for interfacing with the document processing system over a data network.

The document processing system includes a registering component that encrypts the document and registers it with the system, an assigning component which designates one or more areas of the document for signature tasks by specified individuals, a verification component which controls access to the document, and a signing component for allowing review of the document and executing an electronic signature in each of the designated areas of the document, each specific location of the electronic signature placement being recorded in the digest of the document signing. The document processing system also includes a storing component for storing the electronic document and user credentials, a retrieval component for allowing retrieval of documents with previously assigned signature tasks and for allowing retrieval of user credentials, and an audit component for storing transaction history of registered documents.

In an alternative embodiment, the remotely located computer-based systems include a posting component that secures the electronic document and then sends it to the document processing system over a data network.

In yet an alternative embodiment, the remotely located computer-based systems include a converter component for converting the electronic document from its native format into an alternate format.

As will be readily appreciated from the foregoing summary, the invention provides a system and method for allowing users at remote locations to sign and designate for signature specific areas of an electronic document in a secure environment.

### BRIEF DESCRIPTION OF THE DRAWINGS

The preferred and alternative embodiments of the present invention are described in detail below with reference to the following drawings.

FIG. 1 is a system block diagram formed in accordance with the present invention;

FIG. 2 is a flow diagram for sending an electronic document and portions thereof for signing;

FIG. 3 is a flow diagram for receiving and signing an electronic document;

FIG. 4 is a flow diagram for retrieving and storing an electronic document;

FIG. 5 is a screen shot of an embodiment of the present invention illustrating icons used to identify specific areas of an electronic document for approval; and

FIG. 6 is a screen shot of an embodiment of the present invention illustrating visual identifiers used to represent signatures and initials within an electronic document.

### DETAILED DESCRIPTION OF THE PREFERRED EMBODIMENT

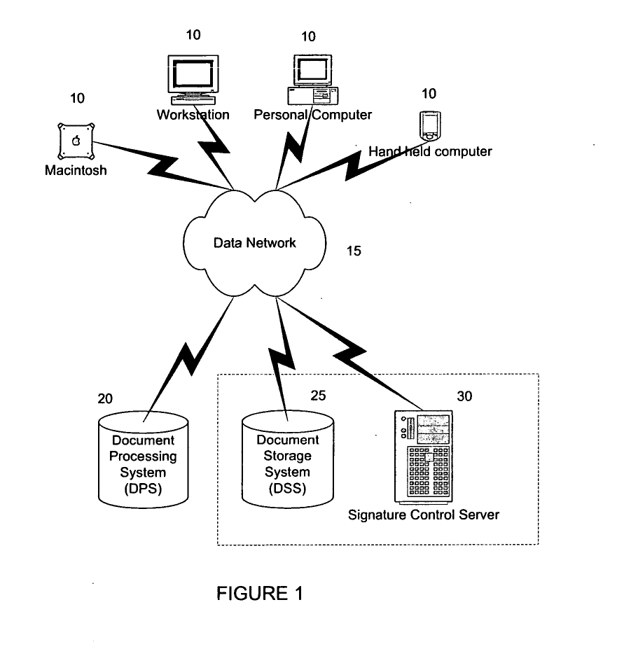

The present invention is a digital signature system and method for electronically signing documents. A preferred embodiment is shown in FIG. 1. The system shown in FIG. 1 includes one or more document processing systems 20, such as those provided by DocuSign™, connected over a public or private data network 15 to a plurality of user systems 10. In an alternative embodiment the system further includes a signature control server 30 connected over the network 15 to one or more document processing systems 20. The signature control server 30 stores information pertaining to subscribing users' signature information, such as the style and form of the users' electronic signatures. The document processing system 20 stores registered document information, user profiles, security authorization information, and copies of the users' electronic signatures. In yet an alternative embodiment, the local document processing system 20 includes a referenced path to one or more document storage systems 25.

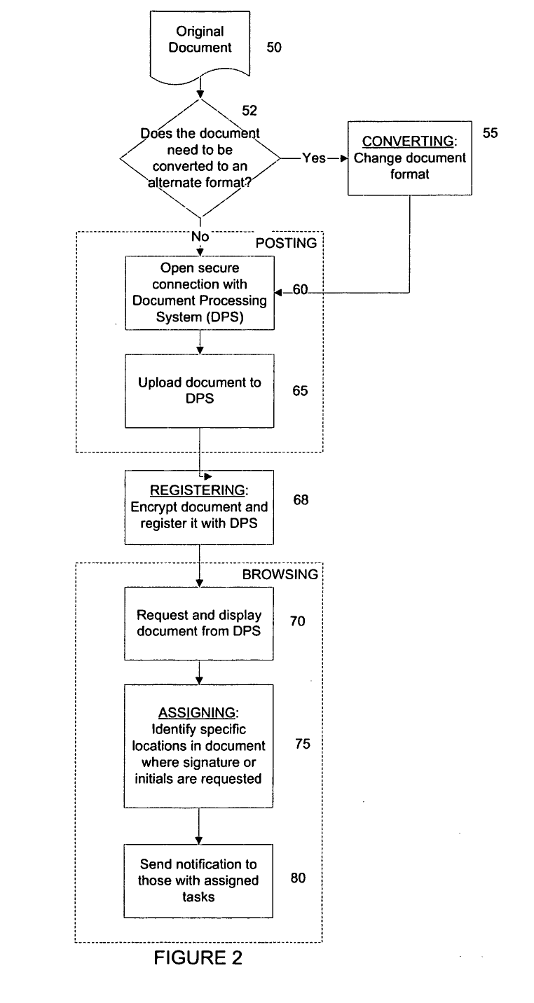

FIG. 2 illustrates the preferred methodology for associating an electronic signature with a document or certain specific areas of a document stored in the system 20.

At block 50, a user using a user system 10 creates or retrieves an electronic document that they wish to designate for review and signing by others. Examples of electronic documents include any type of file output by office utility applications (e.g. MS Word, Adobe Acrobat, AutoCAD, etc.) or form generating applications (e.g. Harland LaserPRO, REForms ZipForm, etc.). In an alternative embodiment of the present invention, at blocks 52 and 55 the document created or selected in block 50 may be converted from its original format into an alternate format for processing.

At block 60, the user system 10 opens a secure connection with the document processing system 20 over the network 15. Once a secure connection is established, at block 65 the user system 10 uploads the electronic document to the document processing system 20. At block 68, upon successful upload, the system 20 encrypts the document and registers information about the document such as submission date, ownership and access control. At block 70, the user system 10 sends a request to the document processing system 20 to display the document in a standard Internet browser or user interface screen on the user system 10.

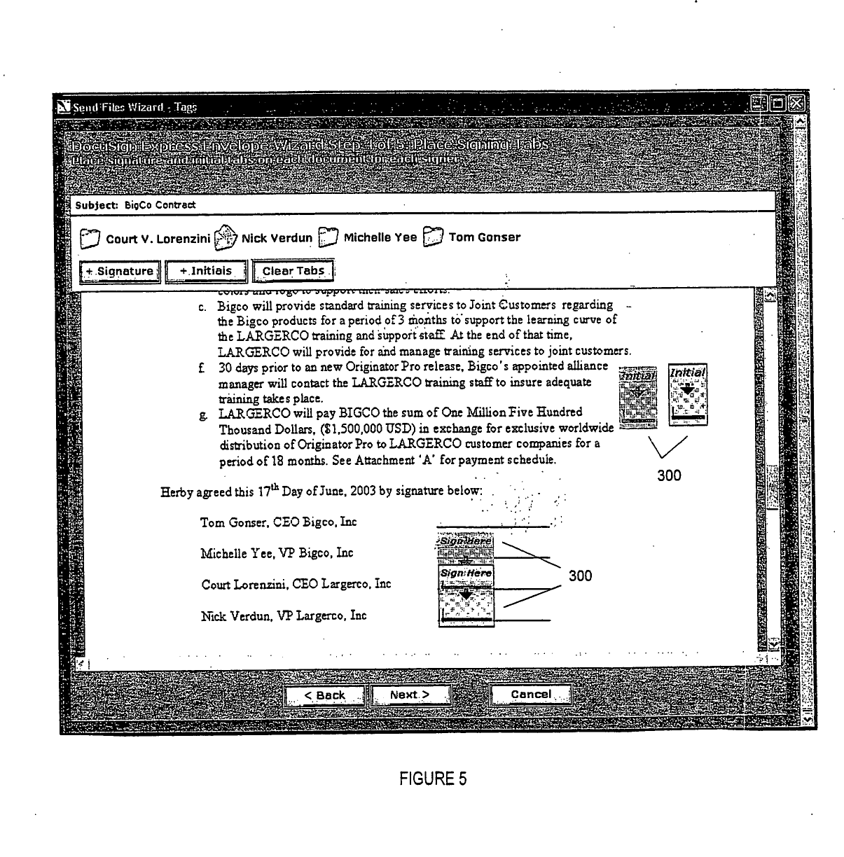

At block 75, the user identifies one or more areas of the document requiring review and approval. One possible embodiment of this is shown in FIG. 5 wherein the section of the document requiring approval is identified by placing icons 300 in the document locations where approval is requested. In an alternate embodiment, other ways of highlighting or otherwise visually differentiating the areas of the document where approval is requested may be used. The system records the absolute locations of these visual identifiers in the signing record.

At block 80, the document processing system 20 sends notification to those individuals assigned to review and approve the document.

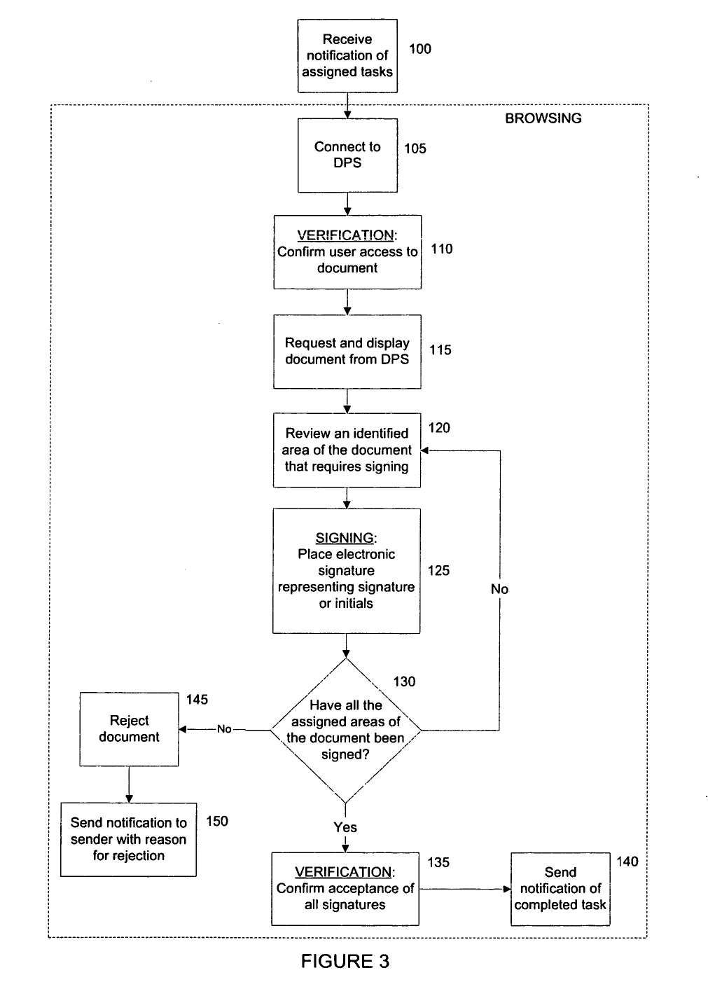

FIG. 3 illustrates the preferred methodology of the present invention for receiving and signing an electronic document registered with the document processing system 20. At block 100, the user receives a notification that they have assigned tasks. At block 105, the user connects to the document processing system 20, preferably using a standard Internet browser or other user interface component. At block 110, the user verifies their identity to confirm access to the document. Once the user identity is verified in block 110, at block 115 the browser sends a request to the system 20 to display the document on the user system 10. As the system 20 retrieves the document it compares the original electronic hash of the document with the current hash. If the underlying document has not been altered, it will be rendered correctly, if not, it will fail. This mechanism ensures that the document is unchanged.

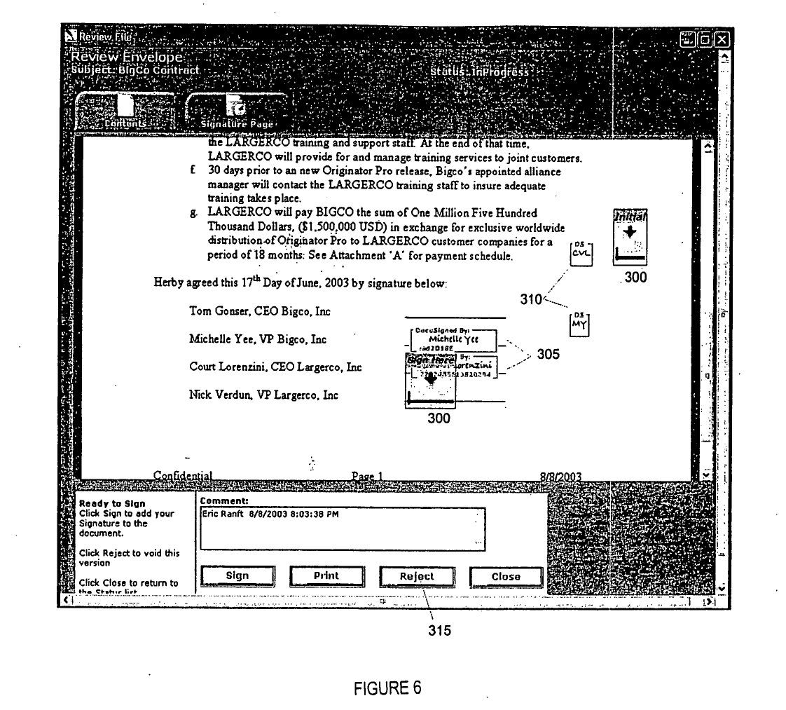

At block 120, the user reviews the document, including the specific areas where their approval has been requested. With further reference to FIG. 6, at block 125, for each icon 300 or other visual identifier that is assigned to them, the user is able to place a unique electronic signature 305 representing their signature or initials 310. These electronic signatures (305 and 310) are preferably unique identifiers that are created by the user, encrypted and hashed by the system 20, and securely stored on the system 20 behind security access control components such as hardened passwords, identification tokens, or other means. An electronic signature may be in the form of text, sound, graphic or other distinguishing mark. The system 20 assures that each electronic signature is unique by assigning each of them a non-duplicate global identification number. Further, the electronic signatures are identifiable to their owner, and their use is tracked and audited by the system 20 and, in an alternative embodiment, via the signature control server 30.

The application of the electronic signature to the document is complete when the user places their electronic signature in the location that was assigned to them. The electronic signature is then registered by the system 20 to have been placed in a specific absolute location in the document. The electronic signature is not physically placed into the document, but is preferably stored in an “overlay file” that allows it to visually appear in the document during viewing, but will not disrupt the originality of the underlying document through the act of signing.

This process of signing may be repeated in block 130 until the user has electronically signed the document everywhere that was assigned to them. In the event the user does not approve of any portion of the document, at block 145 they may reject 315 the document. If approval is rejected, at block 150 the system sends notification to the sender with a reason for the rejection. At block 135, once all the electronic signatures (305 and 310) have been applied, the user approves the entire transaction by entering their verification credentials again in block 135. At block 140, a notice is sent out to all participants in the transaction that the assigned tasks are complete.

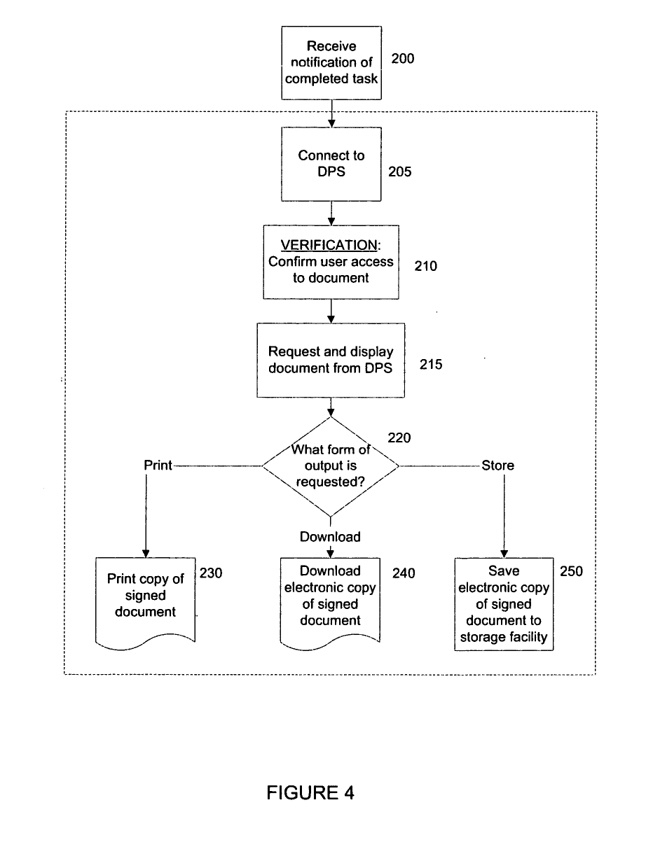

FIG. 4 illustrates the preferred methodology for retrieving and storing a signed document. At block 200, the user is notified that the assigned tasks have been completed. At block 205, using a standard Internet browser or other user interface component, the user connects to the document processing system 20. At block 210, the user verifies their identity to confirm access to the document. Once the user identity is verified in block 210, at block 215 the browser sends a request to the system 20 to display the document on the user system 10. At block 220, the user chooses what form of output they desire for storage of their transaction. Preferred choices include but are not limited to: printing a local copy of the signed document (block 230), downloading an electronic copy of the document to the user system 10 (block 240), or storing an electronic copy of the document in the document processing system 20 or document storage system 25 (block 250).

While the preferred embodiment of the invention has been illustrated and described, as noted above, many changes can be made without departing from the spirit and scope of the invention. For example, the document type may vary limited only by the state of the current technology. Likewise, the precise user interface shown herein may vary according to user preference and system platform demands or preferences. In addition, in some instances, the precise order of the steps of the methodologies may be changed. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. An electronic signature system, comprising:
a data network;
a document processing system, comprising:
a registering component for identifying a particular document created by an application;
an assigning component that designates at least one area of the document for signature tasks by a user;
a verification component that controls access to the document;
a signing component that allows placement of an electronic signature in the at least one designated area of the document;
a storing component for storing the documents and associated signature information; and
a retrieval component for allowing review of the document and associated signature information; and
a remotely located computer-based system in communication with the document processing system via the data network having a user interface component that displays a document on the remote system and interfaces with the document processing system.

2. The system of claim 1, wherein the registering component registers at least one of: submission date, submission time, document version, ownership or access parameters.

3. The system of claim 1, comprising an encryption component for encrypting the document to protect the contents of the document from being altered.

4. The system of claim 1, wherein the assigning component assigns a deadline for completion of the signature tasks by the user.

5. The system of claim 1, wherein the storing component stores the placement location of the electronic signature in the at least one designated area of the document.

6. The system of claim 1, wherein the storing component stores information about the user.

7. The system of claim 6, wherein the information about the user comprises the user's electronic signature.

8. The system of claim 1, comprising an audit component for auditing the transactional history of the document.

9. The system of claim 1, wherein the remotely located computer-based system comprises a posting component that manages a secure communication link between the remotely located computer-based system and the document processing computer-based system over the data network.

10. The system of claim 1, wherein the document processing system comprises a converting component for converting the document from its native format into a format that is no longer editable by the application that created it.

11. The system of claim 1, wherein the remotely located computer-based system comprises a converting component for converting the document from its native format into a format that is no longer editable by the application that created it.

12. A method for electronic signature for use with a document processing computer-based system, comprising:
registering a document with the document processing system;
designating at least one area of the document for signature;
assigning at least one user to sign the document in the designated area;
verifying that the at least one user has access to sign the document;
associating an electronic signature with the at least one designated area of the document;
storing the document and associated signature information; and
displaying the document and associated electronic signature information.

13. The method of claim 12, wherein registering a document comprises registering at least one of: submission date, submission time, document version, ownership or access parameters.

14. The method of claim 12, wherein registering a document comprises encrypting the document to protect the contents of the document from being altered.

15. The method of claim 12, comprising assigning a completion deadline to the at least one user assigned to sign the document.

16. The method of claim 12, wherein storing the document and associated signature information comprises storing the placement location of the electronic signature associated with the at least one designated area of the document.

17. The method of claim 12, wherein storing the document and associated signature information comprises storing information associated with the user's electronic signature.

18. The method of claim 12, comprising auditing the transactional history of the document.

19. The method of claim 12, comprising converting the document from its native format into a format that is no longer editable by the application that created it.

20. A system for allowing various document signing functions, comprising:
a registering component or identifying a document;
an assigning component that designates at least one area of the document for signature;
a verification component that controls access to the document;
a signing component that allows review of the document and execution of an electronic signature in the at least one designated area of the document;
a storing component for storing the document and associated signature information; and
a retrieval component for allowing retrieval of the document and associated signature information.

21. The system of claim 20, wherein the registering component registers at least one of: submission date, submission time, document version, ownership or access parameters.

22. The system of claim 20, comprising an encryption component for encrypting the document to protect the contents of the document from being altered.

23. The system of claim 20, wherein the assigning component assigns a completion deadline for execution of an electronic signature in the at least one designated area of the document.

24. The system of claim 20, wherein the storing component stores the placement location of the electronic signature in the at least one designated area of the document.

25. The system of claim 20, wherein the storing component stores information about a user associated with the document and the various document signing functions provided by the system.

26. The system of claim 25, wherein the information about the user associated with the system comprises the user's electronic signature.

27. The system of claim 20, comprising an audit component for auditing the transactional history of the document.

28. The system of claim 20, wherein the system comprises a converting component for converting the document from its native format into an alternate format.

29. A system for allowing various document signing functions, the system being in communication with a document processing computer-based system via a data network, comprising:
a user interface component for displaying an electronic document to which a user of the computer-based system desires to assign signing functions or to electronically sign; and
a posting component that moves the electronic document to the document processing system over the data network.

30. The system of claim 29, comprising a converting component for converting the document from its native format into a format that is no longer editable by the application that created it.

31. The system of claim 29, wherein the posting component encrypts the document to protect the contents of the document from being altered.
